(19) United States
(12) Patent Application Publication
(10) Pub. No.: US 2011/0228208 A1
(43) Pub. Date: Sep. 22, 2011

(54) LIQUID CRYSTAL DISPLAY PANEL, GLASS SUBSTRATE, METHOD FOR MANUFACTURING LIQUID CRYSTAL DISPLAY PANEL

(75) Inventor: Kentaro TATSUKOSHI, Tokyo (JP)

(73) Assignee: Asahi Glass Company, Limited

(21) Appl. No.: 13/050,785

(22) Filed: Mar. 17, 2011

(30) Foreign Application Priority Data
Mar. 19, 2010 (JP) 2010-064110

(51) Int. Cl. G02F 1/1333; B32B 37/00

(52) U.S. Cl. 349/158; 156/60

(57) ABSTRACT

The present invention relates to a liquid crystal display panel including: two glass substrates facing each other; and a liquid crystal interposed between the two glass substrates, in which one of the two glass substrates has streaks running along a direction of a short side of the glass substrate; and the other glass substrate has streaks running along a direction of a long side of the glass substrate.

### FIELD OF THE INVENTION

The present invention relates to a liquid crystal display panel in which a liquid crystal is interposed between glass substrates and relates to a glass substrate used for the liquid crystal display panel and a method for manufacturing the liquid crystal display panel.

### BACKGROUND OF THE INVENTION

In various liquid crystal display panels, like TFT (Thin Film Transistor) liquid crystal display panels, a liquid crystal is interposed between two substrates. In such a liquid crystal display panel, it is desirable that a spacing (gap) between substrates should be uniform. When the gap is not uniform, unevenness appears in a display, thereby degrading display quality. Therefore, various liquid crystal display panels having uniform gaps has been proposed (see; for instance, Patent Documents 1 and 2).

Patent Document 1 discloses a display device in which mechanical strength of a first substrate is made greater than mechanical strength of a second substrate facing the first substrate and in which the second substrate is formed in alignment with a direction of warpage of the first substrate, to thus align the two substrates in a single direction of warpage. In the display device described in Patent Document 1, two substrates are aligned with each other in terms of the direction of warpage, whereby a uniform gap is formed.

Patent Document 2 discloses a plasma address liquid crystal display device in which a liquid crystal layer is interposed between a lower substrate having an intermediate sheet and an upper substrate. In the plasma address liquid crystal display device described in Patent Document 2, a glass substrate having predetermined rigidity is used as the lower substrate. Meanwhile, a polymer film having predetermined plasticity is used as the upper substrate. Also, the intermediate sheet provided on the lower substrate is an ultra thin glass sheet possessing predetermined flexibility. In the plasma address liquid crystal display device described in Patent Document 2, even when waviness has occurred in the lower substrate, the above configuration lets analogous irregular deformation arise in both the intermediate sheet and the upper substrate, so that a gap can uniformly be controlled.

Various methods have already been known as a method for manufacturing glass sheet. A float process, for instance, is described in Patent Document 3. A common sheet glass manufacturing apparatus that manufactures glass sheet by means of the float process has a bath (hereinafter called a “molten tin bath”) filled with molten metal (e.g., molten tin); a molten tin upper structure that holds an atmosphere contacting the molten tin in a reducing state; and a side sealing wall interposed between the molten tin bath and the molten tin upper structure. During manufacture of the sheet glass performed under the float process, molten glass is continuously allowed to flow into such a sheet glass manufacturing apparatus, and a ribbon-shaped glass sheet having a desired thickness and a desired width is produced while imparting stretching force to the molten glass by means of a roll (called an “assist roll”) inserted from an area from which the side sealing wall is detached. Under the float process, the ribbon-shaped glass sheet is extended sideways and drawn from the sheet glass manufacturing apparatus. In addition, a vertical drawing process for stretching a ribbon-shaped glass sheet in the vertical direction has also been known as a manufacturing method other than the float process. A direction in which a ribbon-shaped glass sheet is drawn from the sheet glass manufacturing apparatus is hereunder described as an “extending direction.”

The ribbon-shaped glass sheet manufactured by means of the float process, or the like, is called a glass ribbon. Cutting a glass sheet from a glass ribbon is called sheet cutting. Further, a glass sheet that is cut from the glass ribbon and not yet subjected to processing, such as polishing, is called a “raw sheet.” The raw sheet is subjected to processing, like polishing, and the thus-processed glass sheet are caused to face each other, whereby a product, such as a liquid crystal display panel, is produced. Treatment for defining a plurality of products when causing glass sheet face each other and cutting the respective products is called “simultaneous multiple cutting treatment.” It is common to manufacture liquid crystal display panels by means of simultaneous multiple cutting treatment.

FIGS. 6A to 6C are descriptive views showing an example glass ribbon and example raw sheets. FIG. 6A shows a glass ribbon drawn from a sheet glass manufacturing apparatus. As shown in FIG. 6B, raw sheets 91 to 93 of various sizes are cut from a glass ribbon 90. As shown in FIG. 6C, raw sheets 91 to 93 are consequently produced. A mode for cutting the raw sheets from the glass ribbon is not particularly limited. For instance. FIGS. 6B and 6C exemplify a case where three sizes of raw sheets are cut, but no limitations are imposed on sizes of raw sheets. The size of a raw sheet to be cut is determined by a size of a liquid crystal display panel to be manufactured, the number of liquid crystal display panels to be simultaneously cut from a raw sheet, and the like.

A raw sheet is in a state where the sheet is not subjected to polishing, or the like, and is usually larger than a liquid crystal display panel which will become a final product. The raw sheet is subjected to processing, such as polishing, to thus produce a glass substrate for use as a liquid crystal display panel. A TFT, an electrode, a color filter, and others, are interposed between two glass substrates, thereby producing a plurality of liquid crystal display panels. Individual liquid crystal display panels are cut through simultaneous multiple cutting treatment. FIGS. 7A and 7B are descriptive views schematically showing processes of simultaneous multiple cutting treatment through which a plurality of liquid crystal display panels manufactured from two glass substrates are divided into individual liquid crystal display panels. FIG. 7A shows a collective entity 100 of liquid crystal display panels produced by interposing liquid crystal, or the like, between glass substrates made by processing a raw sheet. Respective liquid crystal display panels 101 are cut from the collective entity 100. The respective liquid crystal display panels 101 are thus acquired as shown in FIG. 7B.
[Patent Document 1] JP-A-2001-83885 (Paragraph [0010], and FIG. 1)
[Patent Document 2] JP-A-7-43693 (Paragraphs [0007] and [0011], and FIG. 1)
[Patent Document 3] JP-4132198 (Paragraphs [0002] and [0003])

### SUMMARY OF THE INVENTION

A glass ribbon manufactured by the float process, or the like, has streaks running in an extending direction of the glass ribbon. The streaks are striae that develop in a glass sheet (a glass ribbon) in its extending direction for reasons of fluctuations in a thickness of the glass sheet in a direction perpendicular to the extending direction or waviness of the glass sheet. A direction in which streaks run is called a streak direction. The streak direction is identical with an extending direction of a glass ribbon. FIG. 8 is a schematic drawing showing fluctuations in plate thickness along a direction perpendicular to an extending direction of a glass ribbon or waviness of the glass ribbon. FIG. 9 is a schematic drawing showing streaks on a surface of the glass ribbon.

As shown in FIG. 8, fluctuations in plate thickness and waviness of a glass ribbon are small with respect to an extending direction of the glass ribbon 90. Further, fluctuations in plate thickness or waviness of the glass ribbon 90 are relatively large with respect to a direction perpendicular to the extending direction of the glass ribbon 90. As a consequence, areas that will become crests or valleys on a surface of the glass ribbon 90 extend as striae 103. The striae 103 are streaks. A direction in which the streaks 103 run is identical with an extending direction of the glass ribbon 90. Consequently, as shown in FIG. 9, the streaks 103 running in the extending direction develop on the surface of the glass ribbon 90. In order to facilitate comprehension, FIG. 8 shows irregularities on the surface of the glass ribbon 90 in an exaggerated manner.

In the display device described in Patent Document 1, mechanical strength of one of two substrates is made greater than that of the other substrate. Directions of warpage of the two substrates are aligned in one direction, thereby rendering a gap uniform. However, a pitch (spacing) between the streaks 103 exemplified in FIG. 8 is smaller than warpage of the substrate, and the irregularities on the surface of the glass ribbon 90 are also random. Therefore, difficulty is encountered in aligning the streaks of the two substrates with each other. When streaks exist in the glass substrates, the technique described in Patent Document 1 encounters difficulty in making a cell gap uniform.

Also, in the plasma address liquid crystal display device described in Patent Document 2, a glass substrate possessing predetermined rigidity is taken as a lower substrate. An ultra thin glass sheet possessing flexibility is placed on the lower substrate as an intermediate layer, and a polymer film possessing predetermined plasticity is taken as an upper substrate. The intermediate layer and the upper substrate are deformed like waviness of the lower substrate. A gap is uniformly controlled by the deformation. However, as mentioned above, the pitch between the streaks 103 (see FIG. 8) is small. Hence, when streaks exist in the lower substrate, it is difficult to deform the upper substrate like the streaks. The technique described in Patent Document 2 encounters difficulty in making the cell gap uniform.

When a liquid crystal display panel is produced by using raw sheets cut from the glass ribbon 90 having the streaks 103 (see FIGS. 8 and 9), raw sheets are polished to such an extent that the streaks 103 disappear. A liquid crystal display panel having a uniform gap can be produced by using the glass sheet having no streaks. However, in this case, polishing involves consumption of time.

Accordingly, the present invention aims at providing a liquid crystal display panel that enables shortening of a time to polish a glass substrate and that provides superior display quality, a method for manufacturing the liquid crystal display panel, and a glass substrate applied to the liquid crystal display panel.

The present invention relates to a liquid crystal display panel comprising:

two glass substrates facing each other; and

a liquid crystal interposed between said two glass substrates,

wherein one of said two glass substrates has streaks running along a direction of a short side of the glass substrate; and

the other glass substrate has streaks running along a direction of a long side of the glass substrate.

Also, the present invention relates to a glass substrate to be used in the liquid crystal display.

Furthermore, the present invention relates to a method for manufacturing a liquid crystal display panel, said method comprising:

a step of interposing a liquid crystal between two glass substrates facing each other,

wherein, when the two glass substrates are caused to face each other, one of said two glass substrates, which has streaks running along a direction of a short side and the other glass substrate which has streaks running along a direction of a long side are caused to face each other.

The present invention makes it possible to shorten a time to polish a glass substrate, and superior display quality is provided.

### BRIEF DESCRIPTION OF THE DRAWINGS

FIG. 1 is a descriptive view showing glass substrates that make up a pair in a liquid crystal display panel of the present invention.

FIG. 2 is a schematic view showing an example configuration of the liquid crystal display panel of the present invention.

FIG. 3 is a flowchart showing an example method for manufacturing the liquid crystal display panel of the present invention.

FIGS. 4A and 4B are descriptive views showing longitudinal streaks and lateral streaks.

FIG. 5 is a descriptive view showing example in which a raw sheet having longitudinal streaks and another raw sheet having lateral streaks are cut from a glass ribbon.

FIGS. 6A to 6C are descriptive views showing an example glass ribbon and example raw sheets.

FIGS. 7A and 7B are descriptive views schematically showing processes for simultaneous multiple cutting treatment.

FIG. 8 is a schematic view showing fluctuations in plate thickness in a direction perpendicular to an extending direction of a glass ribbon and waviness of the glass ribbon.

FIG. 9 is a schematic view showing streaks on a surface of the glass ribbon.

### DETAILED DESCRIPTION OF THE INVENTION

An embodiment of the present invention is hereunder described by reference to the drawings.

In the following descriptions, an explanation is given to a case where a liquid crystal display panel is a TFT liquid crystal display panel that provides a color display. The present invention is also applicable to a liquid crystal display panel other than the TFT liquid crystal display panel. The present invention is also applicable to a liquid crystal display panel that provides a monochrome display.

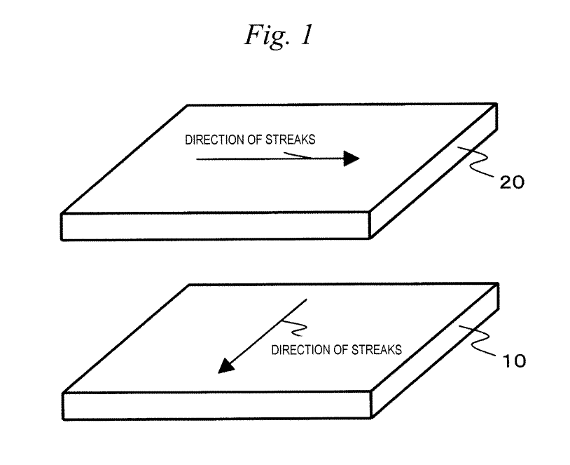

FIG. 1 shows glass substrates that make up a pair in a liquid crystal display panel of the present invention. A TFT, a display electrode, a source wire, a gate wire, and others (omitted from the drawing), are arranged on a first glass substrate 10. Also, a color material film that is to become a color filter, a common electrode, and others (omitted from the drawing), are arranged on a second glass substrate 20. The first glass substrate 10 and the second glass substrate 20 are caused to face each other with liquid crystal (omitted from the drawing) interposed therebetween, whereby a liquid crystal display panel is formed.

However, the first glass substrate 10 and the second glass substrate 20 are caused to face each other in such a way that directions of streaks on the respective glass substrates intersect at right angles. Namely, the glass substrates are caused to face each other in such a way that a direction of the streaks on the first glass substrate 10 and a direction of the streaks on the second glass substrate 20 intersect at right angles.

In other words, one of the glass substrates facing each other can be said to have streaks running in a lateral direction, and the other glass substrate can be said to have streaks running in a longitudinal direction. Incidentally, the present invention does not exclude the case where the length of the lateral direction and the length of the longitudinal direction are the same, and is not particularly limited as long as a direction of the streaks of the glass substrate and a direction of the streaks of the other glass substrate intersect at right angles.

The first glass substrate 10 and the second glass substrate 20 are caused to face each other in such a way that their streaks intersect at right angles, whereby a random characteristic of variations in a gap between the glass substrates 10 and 20 is enhanced. As a consequence, variations in the gap become less conspicuous, and superior display quality is obtained. Specifically, regions where a great gap exists and regions where a small gap exists become present as a result of existence of the streaks. Since the directions of the streaks intersect at right angles, these regions are present in a distributed manner as regions having very small areas. If the regions having a large gap and the regions having a small gap respectively have certain degrees of areas, display irregularities will become conspicuous. However, the regions having a large gap and the regions having a small gap are present in a distributed manner as regions respectively having very small areas. Thereby, even when the gaps is not uniform, superior display quality that makes the display irregularities less conspicuous is yielded.

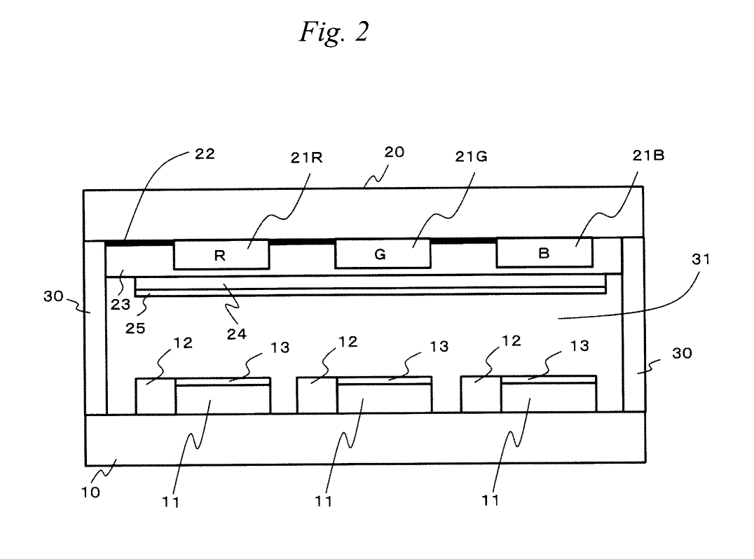

FIG. 2 is a schematic view showing a configuration example of the liquid crystal display panel of the present invention. As mentioned above, the liquid crystal display panel of the present invention has the first glass substrate 10 and the second glass substrate 20 that face each other in such a way that directions of the streaks intersect at right angles.

TFTs 12 and display electrodes 11 are provided on the first glass substrate 10, whereby alignment films 13 are formed on the respective display electrodes 11. Accordingly, the first glass substrate 10 can be mentioned as a glass substrate for TFT. A one-to-one correspondence exists between the TFTs 12 and the display electrodes 11, and locations of the respective display electrodes 11 serve as pixels in the liquid crystal display panel. Further, each of the TFTs 12 is connected to a source wire and a gate wire (omitted from the drawing). Each of the display electrodes 11 is subjected to voltage control according to a voltage supplied to the TFT 12 from the source wire and the gate wire.

Color material films 21R, 21G and 21B that are to become color filters and black matrices 22 are provided on the second glass substrate 20. Accordingly, the second glass substrate 20 can be said to be a glass substrate for a color filter. Further, a protective film 23 is formed so as to cover the color material films 21R, 21G and 21B and the black matrices 22, and a common electrode 24 and an alignment film 25 are formed on the protective film 23.

The color material films 21R, 21G and 21B are color filters that permit passage of only light of predetermined colors. The color material film 21R allows passage of only red light; the color material film 21G allows passage of only green light; and the color material film 21B allows passage of only blue light. The color material films 21R, 21G and 21B are arranged so as to overlap their respective display electrodes 11. As a consequence, a combination consisting of a red pixel, a green pixel, and a blue pixel can be acquired. A display of a variety of colors is realized by means of combinations of the pixels, thereby making it possible to display an image in color.

A layout of the color material films 21R, 21G and 21B and the display electrodes 11 is described in more detail. When the display electrodes 11 are positioned on the first substrate 10 and when the color material films 21R, 21G and 21B are positioned on the second substrate 20, the color material films 21R, 21G and 21B and the display electrodes 11 are arranged in such a way that overlaps exist between the positions of the color material films 21R, 21G and 21B and the positions of the respective display electrodes 11 when the first substrate 10 and the second substrate 20 are disposed to face each other in such a way that the direction of the streaks of the first substrate 10 and the direction of the streaks of the second substrate 20 intersect at right angles.

Black matrices 22 prevent leakage of light between the pixels. A protective film 23 protects the color material films 21R, 21G and 21B and the black matrices 22.

A common electrode 24 is an electrode facing the respective display electrodes 11. The common electrode 24 is held at a given voltage by means of a common electrode driver (not shown) connected to the liquid crystal display panel.

The liquid crystal display panel has sealing materials 30 that hold liquid crystal 31 between the substrates 10 and 20, thereby sealing the liquid crystal 31.

The respective alignment films 13 and an alignment film 25 are subjected to rubbing processing, and orientations of liquid crystal are aligned in a rubbed direction. The voltages of the display electrodes 11 are controlled while the orientations of liquid crystal are aligned by the respective alignment films 13 and 25, whereby voltages are applied to the liquid crystal interposed between the display electrodes 11 and the corresponding common electrode 24, whereby a state of liquid crystal changes. The state of liquid crystal in each of the pixels is changed according to image data, whereby an image (a color image in the example shown in FIG. 2) is displayed.

In the liquid crystal display panel exemplified in FIG. 2, the first substrate 10 and the second substrate 20 are arranged such that the direction of the streaks of the first substrate 10 and the direction of the streaks of the second substrate 20 intersect at right angles. By means of such a configuration, the regions where a gap is large and the regions where a gap is small are present in a distributed manner as regions respectively having small areas, as mentioned above. Hence, superior display quality that does not cause conspicuous display irregularities is obtained.

Even when the streaks are present in the invention first substrate 10 and the second substrate 20, superior display quality is yielded. Accordingly, there is required only a small extent to which a raw sheet cut from the glass ribbon is polished. Therefore, it is possible to shorten a time to polish during raw sheet processing.

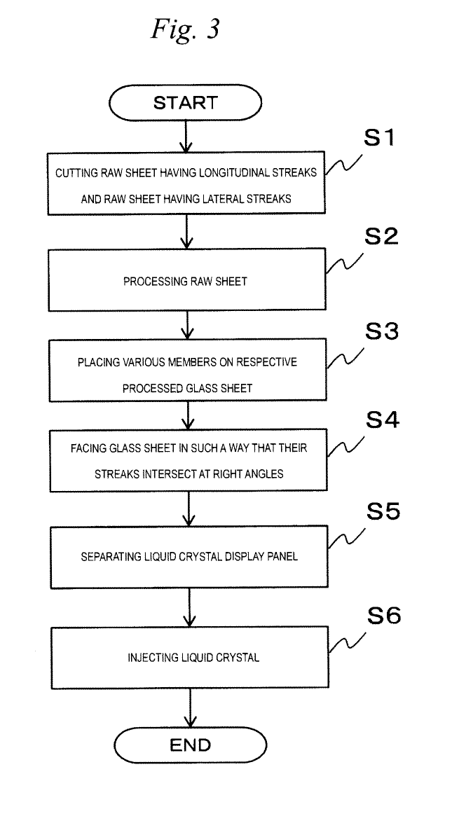

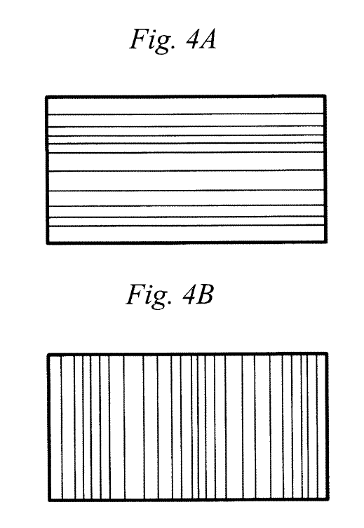

A method for manufacturing a liquid crystal display panel of the present invention is now described. FIG. 3 is a flowchart showing an example method for manufacturing a liquid crystal display panel of the present invention. First, raw sheets having the same size are cut from a glass ribbon, wherein one plate has longitudinal streaks and wherein the other plate has lateral streaks (step S1). FIGS. 4A and 4B are descriptive views showing longitudinal streaks and lateral streaks. As shown in FIG. 4A, the longitudinal streaks are streaks that run along a longitudinal direction (i.e., a direction of a long side) of the glass sheet. Further, as shown in FIG. 4B, the lateral streaks are streaks that run along a lateral direction of the glass sheet.

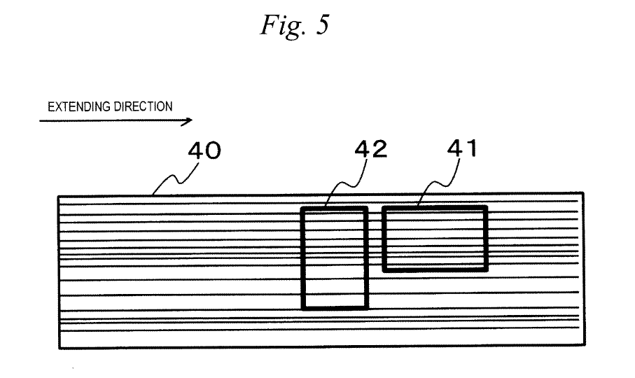

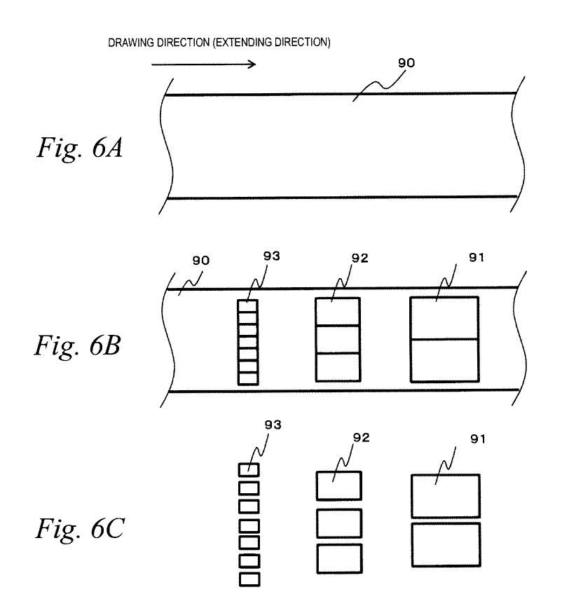

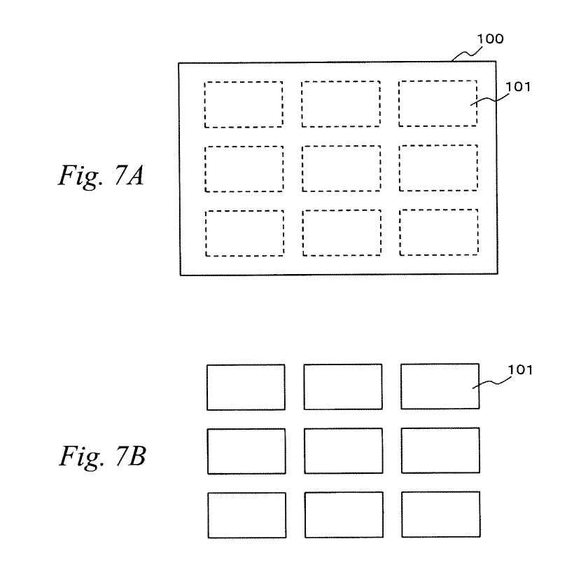

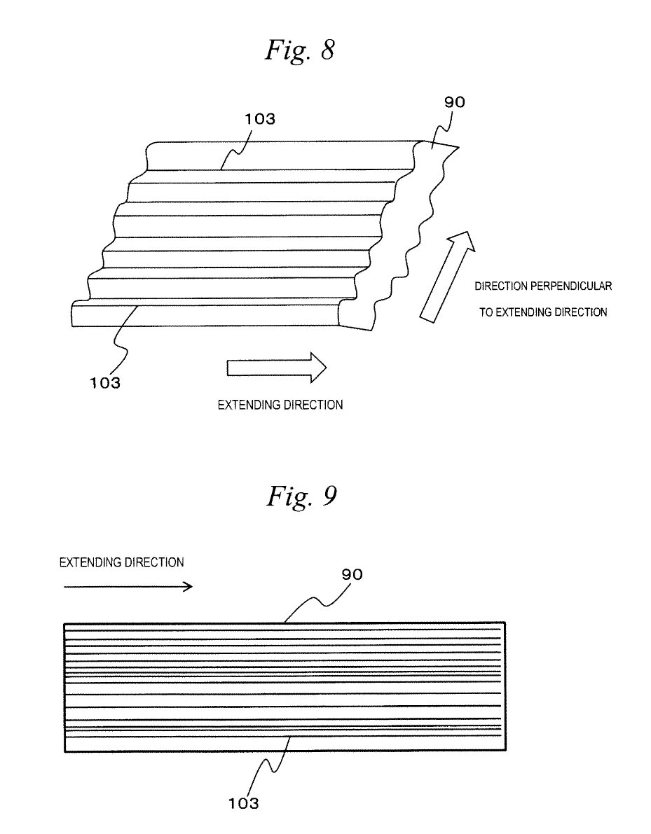

FIG. 5 is a descriptive view showing an example in which a raw sheet having longitudinal streaks and a raw sheet having lateral streaks are cut from a glass ribbon in step S1. As shown in FIG. 5, a rectangular raw sheet 41 whose long sides are oriented in the same direction as the extending direction of a glass ribbon 40 may also be cut as an raw sheet having longitudinal streaks. A rectangular raw sheet 42 whose short sides are oriented in the same direction as the extending direction of the glass ribbon 40 may also be cut as a raw sheet having lateral streaks. Thus, the raw sheets can also be cut. FIG. 5 is an exemplification of a method for cutting a plate in step S1. Plate cutting may also be performed by means of another method. For instance, there is a case where a raw sheet having longitudinal streaks is cut from the glass ribbon 40 and where the raw sheet is split along its long side, whereby an raw sheet having lateral streaks is obtained. As mentioned above, a raw sheet having desired streaks can also be cut by dividing the raw sheet cut from the ribbon.

For instance, a glass ribbon produced by the float process can be used as the glass ribbon used in step S1. However, a glass ribbon produced by a method other than the float process (e.g., a vertical drawing process, or the like) can also be used.

The thus-cut raw sheet 41 having longitudinal streaks and the thus-cute raw sheet 42 having lateral streaks are subjected to processing, such as chamfering and polishing subsequent to step S1 (step S2). However, during polishing treatment, the raw sheets do not need to be polished until the streaks disappear. The longitudinal streaks and the lateral streaks may exist in the glass sheets processed in step S2.

Subsequently, various members are formed in the glass sheet having longitudinal streaks and the glass sheet having lateral streaks that are obtained in step S2 (step S3). Namely, any one of the glass sheet having longitudinal streaks and the glass sheet having lateral streaks is taken as the first glass substrate 10 (see FIG. 2) and the other plate is taken as the second glass substrate 20 (see FIG. 2). Either the glass sheet having the longitudinal streaks or the glass sheet having the lateral streaks can be taken as the first glass substrate 10. For instance, a plurality of combinations that each consists of the TFT 12 and the display electrode 11 are arranged in a matrix pattern on the first glass substrate 10, and the alignment films 13 are formed on the respective display electrodes 11. The color material films 21R, 21G and 21B and the black matrices 22 are formed on the second glass substrate 20, and the protective film 23 is formed over them. At this time, the color material films 21R, 21G and 21B and the display electrodes 11 are arranged in such a way that overlaps exist between the locations of the color material films 21R, 21G and 21B and the locations of the respective display electrodes 11 when the first substrate 10 and the second substrate 20 are caused to face each other in such a way that a direction of the streaks of the first substrate 10 and a direction of the streaks of the second substrate 20 intersect at right angles. The common electrode 24 is formed over the protective film 23 formed on the second substrate 20. Further, the alignment film 25 is formed over the common electrode 24. The alignment films 13 and the alignment film 25 are rubbed.

In step S3, members equal in number to a plurality of liquid crystal display panels are arranged on the first glass substrate 10 and the second glass substrate 20 so that the plurality of liquid crystal display panels can be simultaneously cut.

Subsequent to step S3, the sealing material 30 (see FIG. 2) is formed on either the first substrate 10 or the second substrate 20 or on both of them, and the first substrate 10 and the second substrate 20 are caused to face each other such that the streaks of the first substrate 10 and the streaks of the second substrate 20 intersect at right angles (step S4). As a consequence, an aggregate of empty cells in which a plurality of empty cells are joined by means of the glass substrates 10 and 20 is produced. Subsequent to step S4, the respective liquid crystal display panels (the empty cells at this point in time) are cut (step S5). Namely, empty cells are simultaneously cut. Subsequently, liquid crystal is injected into the respective empty cells (step S6).

Through processing described above, there are produced a plurality of liquid crystal display panels in which the direction of the streaks of the first substrate 10 and the direction of the streaks of the second substrate 20 intersect at right angles. As mentioned above, in the liquid crystal display panel, superior display quality can be realized. Further, the time required for polishing in step S2 becomes shorter.

While the invention has been described in detail with reference to specific embodiments thereof, it will be apparent to one skilled in the art that various changes and modifications can be made therein without departing from the spirit and scope thereof.

Incidentally, the present application is based on Japanese Patent Applications No. 2010-064110 filed on Mar. 19, 2010, and the contents are incorporated herein by reference.

Also, all the references cited herein are incorporated as a whole.

The present invention is suitably applicable to a liquid crystal display panel having liquid crystal interposed between glass substrates.

### DESCRIPTION OF THE REFERENCE NUMERALS

10 FIRST GLASS SUBSTRATE
11 DISPLAY ELECTRODE
12 TFT
13, 25 ALIGNMENT FILM
20 SECOND GLASS SUBSTRATE
21R, 21G, 21B COLOR MATERIAL FILM (COLOR FILTER)
22 BLACK MATRIX
23 PROTECTIVE FILM
24 COMMON ELECTRODE
30 SEALING MATERIAL
31 LIQUID CRYSTAL
40 GLASS RIBBON
41 RAW SHEET HAVING LONGITUDINAL STREAKS
42 RAW SHEET HAVING LATERAL STREAKS

What is claimed is:

1. A liquid crystal display panel comprising:
two glass substrates facing each other; and
a liquid crystal interposed between the two glass substrates,
wherein one of the two glass substrates has streaks running along a direction of a short side of the glass substrate; and
the other glass substrate has streaks running along a direction of a long side of the glass substrate.

2. A glass substrate to be used in the liquid crystal display panel according to claim 1.

3. A method for manufacturing a liquid crystal display panel, said method comprising:
a step of interposing a liquid crystal between two glass substrates facing each other,
wherein, when the two glass substrates are caused to face each other, one of the two glass substrates, which has streaks running along a direction of a short side and the other glass substrate which has streaks running along a direction of a long side are caused to face each other.
